(19) United States
(12) Patent Application Publication
(10) Pub. No.: US 2015/0343878 A1
(43) Pub. Date: Dec. 3, 2015

(54) MOTOR VEHICLE WITH AUTOMATIC START-STOP SYSTEM AND WITH A HEATING SYSTEM HEAT EXCHANGER FUNCTIONING AS A COLD RESERVOIR

(71) Applicant: GM GLOBAL TECHNOLOGY OPERATIONS LLC, Detroit, MI (US)

(72) Inventor: Kai-Ove PIETSCH, Weiterstadt (DE)

(73) Assignee: GM GLOBAL TECHNOLOGY OPERATIONS LLC, Detroit, MI (US)

(21) Appl. No.: 14/727,094

(22) Filed: Jun. 1, 2015

(30) Foreign Application Priority Data
May 31, 2014 (DE) 102014008274.1

(51) Int. Cl. B60H 1/00

(52) U.S. Cl. CPC B60H 1/00035; B60H 2001/0015

(57) ABSTRACT

A motor vehicle with a drive, a control with automatic start-stop system and with an HVAC device, which includes a heating system heat exchanger that can be thermally coupled to the drive and an evaporator that is embedded in a refrigerant circuit of the air-conditioning system. The heating system heat exchanger can with activated automatic start-stop system be thermally decoupled from the drive and for use as cold reservoir in a stop phase of the automatic start-stop system, can be thermally coupled to the evaporator.

### CROSS-REFERENCE TO RELATED APPLICATION

This application claims priority to German Patent Application No. 102014008274.1, tiled May 31, 2014, which is incorporated herein by reference in its entirety.

### TECHNICAL FIELD

This present disclosure pertains to a motor vehicle with a drive, a control with automatic start-stop function and with a heating, ventilation and air-conditioning device, and more specifically to a method for controlling a heating, ventilation and air-conditioning device of a motor vehicle equipped with an automatic start-stop function and to a computer program for controlling such a heating, ventilation and air-conditioning device.

### BACKGROUND

To reduce the pollutant emission and for reducing the energy and fuel consumption, modern motor vehicles have an automatic start-stop system. Accordingly, the drive of the motor vehicle, mostly in the form of an internal combustion engine, can be automatically switched off during stationary phases of the motor vehicle and reactivated when required for example as a consequence of actuating the clutch or accelerator pedal. With automatic start-stop function activated, the motor vehicle drive is switched off in stationary phases of the motor vehicle only in particular when the operating conditions and surrounding parameters of the motor vehicle permit.

In the case of motor vehicles with air-conditioning system, which are operated by a compressor drive by the motor vehicle drive, switching-off the drive during a stop phase of the automatic start-stop system results in that the evaporator of the air-conditioning system cooling down the interior air is no longer actively cooled. In the case of prolonged stationary phases of the motor vehicle, the evaporator, through the continuous admission of comparatively warm air, is heated to a temperature level at which cooling of the motor vehicle interior is only possible conditionally or to a limited degree. Conventional start-stop systems for motor vehicles therefore provide prematurely interrupting the stop phase of the drive in the stationary state of the motor vehicle, i.e. restart the drive in the stationary state of the motor vehicle as it were, in order to reinitiate active cooling of the evaporator.

It is generally desirable to delay the inevitable heating of an evaporator with switched-off motor vehicle drive for as long as possible. A method for controlling a motor vehicle air-conditioning system with cold reservoir is disclosed in DE 10 2006 022 249 A1, wherein the evaporator is coupled to a cold reservoir including a storage medium, which stores cold through phase conversion. Providing such a separate cold reservoir solely for implementing the automatic start-stop function however leads to an increase of the motor vehicle gross weight and additionally contributes to an increase of the production costs.

### SUMMARY

In accordance with the present disclosure a motor vehicle, a method and a computer program is provided in which the heating-up of a vehicle interior with switched-off motor vehicle drive can be delayed without providing separate or additional components. The method concerned, or the motor vehicle concerned, should be implementable in a preferably simple and cost-effective manner and be suitable for low-maintenance or maintenance-free long-term operation.

In this regard, a motor vehicle with a drive, typically with an internal combustion engine, having an automatic start-stop function and a heating, ventilation and air-conditioning device is provided. The air-conditioning device, which can also be called HVAC module (heating, ventilation and air-conditioning module), typically includes a housing with an inlet and with one or multiple outlets for air to be thermally conditioned. For thermally conditioning supplied air, the HVAC device includes an evaporator incorporated in a refrigerant circuit of an air-conditioning system and a heating system heat exchanger that can be thermally coupled to the drive of the motor vehicle. By means of the heating system heat exchanger, which is generally also called heater core, the air supplied to the HVAC device can be heated. By means of the evaporator, the air, by contrast, can be cooled down.

In the heating, ventilation and air-conditioning device, consequently in its housing, a first and a second flow path for supplied air are provided downstream of the evaporator, typically between evaporator and heating system heat exchanger. The first flow path in this case leads through the heating system heat exchanger while the second flow path leads past the heating system heat exchanger, thereby functioning as bypass. The air flowing via the second flow path bypasses the heating system heat exchanger while air flowing via the first flow path is admitted to the heating system heat exchanger.

By at least partially dividing or complete guiding of the air along the first and/or the second flow path, the heating system heat exchanger thermally decoupled from the drive can be cooled down with activated automatic start-stop function with the already cooled down air from the evaporator and used as cold reservoir for and during a start-stop phase of the automatic start-stop system. To maximally cool or pre-cool the heating system heat exchanger, the air downstream of the evaporator is completely conducted via the first flow path.

With activated automatic start-stop system, the heating system heat exchanger is thermally decoupled from the drive of the motor vehicle. With activated automatic start-stop system, it can be used in particular as cold reservoir for and during a stop phase of the automatic start-stop system. For this purpose, the heating system heat exchanger is thermally coupled to the evaporator at least with activated automatic start-stop system. In this regard, the heating system heat exchanger can be used as cold reservoir for the automatic start-stop system. The heating system heat exchanger, in particular the coolant present in the heating system heat exchanger, which typically has a high water content, or which apart from an antifreeze addition, largely consists of water, can be employed in this regard as cold reservoir during the operation of the air-conditioning system.

During the operation of the air-conditioning system, the heating system heat exchanger can be cooled down to a predetermined temperature level through the thermal coupling to the evaporator of the air-conditioning system. By being thermally decoupled from the drive, which is easily possible during the cooling mode of the HVAC device, the heating system heat exchanger together with the coolant contained therein is subjected to cooling-down. During a stop phase of the automatic start-stop system, during which the motor vehicle drive is switched off, and the evaporator of the air-conditioning system is not subjected to any further active cooling, the air supplied to the HVAC device can be further cooled both by the evaporator and also by the cooled-down heating system heat exchanger. The time interval, pending which the vehicle interior reaches a maximum permissible temperature level with switched-off motor vehicle drive, can be effectively prolonged in this way.

The thermal mass of the heating system heat exchanger that is present in the motor vehicle anyway can be used in this manner particularly efficiently and in a versatile manner not only for heating the air to be supplied to a motor vehicle interior but also for cooling the air, in particular during stop phases of an automatic start-stop system. Providing a separate cold reservoir and making available additional components for a cold reservoir can be omitted in this way. The solution proposed here in this regard contributes to the minimization of weight and consumption of the motor vehicle.

According to a further configuration of the motor vehicle, the heating system heat exchanger with activated automatic start-stop system is thermally decoupled from the drive. Coupling or decoupling can be affected by means of a control. This control can be provided as a separate control for the HVAC device and implemented accordingly. However it is also conceivable that the mentioned control is implemented in the control unit of the motor vehicle, incorporated in the central control unit of the motor vehicle as it were. The control typically includes a memory and a processor and is data-coupled to the HVAC device. In the control, the automatic start-stop system can also be implemented in particular. In this regard, the automatic start-stop system can for example be realized in the control purely as software.

The control is designed in particular in order to detect the activation of the automatic start-stop system and accordingly, as a consequence of an activation of the automatic start-stop system or with activated automatic start-stop system, thermally decouple the heating system heat exchanger from the drive and thermally couple the heating system heat exchanger to the drive. For such thermal coupling and decoupling, the control is typically connected to suitable actuating drives, by means of which the heating system heat exchanger can be thermally coupled or thermally decoupled in the required manner. For realizing the advantageous configuration described here it is merely required in this regard to expand the scope of the function of a control that is present anyway. In this regard, the utilization of the heating system heat exchanger as cold reservoir for the stop phase of the automatic start-stop system can be implemented purely or predominantly by software.

According to a further configuration, the heating system heat exchanger with activated automatic start-stop system is thermally coupled to the evaporator. This thermal coupling typically takes place by an air feed flow onto the heating system heat exchanger via the first flow path. Because of this, the heating system heat exchanger can be cooled down during the operation of the automatic start-stop system.

According to a further configuration, the HVAC device includes a flap. With activated automatic start-stop system, the flap can be transferred into a closed position in which air cooled down by the evaporator can be admitted or is admitted to the heating system heat exchanger. The flap can be actuated in particular via the control. In particular, it is configured as a so-called mixed air flap. Accordingly, it can be provided in particular to transfer the flap into the closed position on activating the automatic start-stop system so that preferentially all air flowing through or via the evaporator is also fed to the heating system heat exchanger. A closed flap is referred to here when the supplied air flows via the heating system heat exchanger. With an opened or open flap, the air, by contrast, is delivered directly into the vehicle interior bypassing the heating system heat exchanger.

The closed flap in a manner of speaking forces a flow series connection of evaporator and heating system heat exchanger. In this regard, thermal coupling between heating system heat exchanger and evaporator can be achieved by way of the air already cooled down by the evaporator. Since the heating system heat exchanger is thermally decoupled from the drive of the motor vehicle, the same, once it has been cooled down to a predetermined temperature level, hardly contributes to the heating of the air cooled by the evaporator any more. Merely in short phases after the activation, otherwise undesirable heating of the air to be fed to the vehicle interior can still briefly occur via the relatively warm heating system heat exchanger if appropriate.

In that the thermal coupling between evaporator and heating system heat exchanger preferentially exclusively takes place via the air that has already been cooled by the evaporator, further structural measures for bringing about thermal coupling need not be taken. The thermal coupling of evaporator and heating system heat exchanger by means of supplied air therefore proves to be particularly advantageous with respect to production and assembly.

According to a further configuration, the heating system heat exchanger is thermally coupled to the drive via a cooling circuit. The heating system heat exchanger is incorporated in the cooling circuit. In particular in heating mode, the heating system heat exchanger can make available a part of the waste heat of the drive to the HVAC device as heating energy. In such a heating mode, the air supplied to the HVAC device can be heated to suit requirements. For the operation of an air-conditioning system of a motor vehicle with automatic start-stop function, the heating system heat exchanger is not employed for heating but for cooling purposes.

To this end it is required to thermally decouple the heating system heat exchanger from the cooling circuit. To this end, the cooling circuit includes at least one shut-off valve that can be actuated by means of the control, with which the heating system heat exchanger with activated automatic start-stop system can be thermally decoupled or is thermally decoupled from the drive of the motor vehicle. An inflow or outflow for the heating system heat exchanger is completely shut off preferentially by means of the shut-off valve. The coolant that is present in the heating system heat exchanger and not circulating as a consequence of the shut-off, can for example make available, because of its comparatively high water content, a substantial heat storage capacity and thus a comparatively large thermal mass for the cold reservoir to be realized by means of the heating system heat exchanger.

According to a further configuration, the air-conditioning system of the motor vehicle includes a compressor driven by the drive of the motor vehicle. The same can be controlled for regulating the air temperature with activated automatic start-stop system. By means of the controllable compressor, the cooling output of the air-conditioning system can be adapted to suit requirements. In particular, the temperature of the evaporator, thus also the temperature of the heating system heat exchanger can thereby be controlled or adjusted in the start-stop mode. By means of the controllable compressor, the temperature of the air that can be cooled by means of evaporator and heating system heat exchanger can be changed in this regard with air-conditioning system switched on. By means of the controllable compressor, a temperature control of the air can be realized despite the flap of the HVAC device being in the closing position.

According to a further configuration, the flap, with deactivated automatic start-stop system, can be transferred into a closing position or into an opening position. In the opening position of the flap, the air flowing away from the evaporator can be fed to the vehicle interior subject to bypassing the heating system heat exchanger. This means that with opened flap the air cooled by the evaporator largely flows past the heating system heat exchanger into the vehicle interior without thermal coupling or thermal exchange with the heating system heat exchanger.

The operation of the HVAC device with deactivated automatic start-stop system with opened flap makes possible a particularly low flow resistance within the HVAC device. In this regard, a particularly large air mass can be supplied to the vehicle interior with opened flap. In this configuration, however, the heating system heat exchanger is not cooled or only slightly cooled by the cooled air flowing via or through the evaporator. If the flap with deactivated automatic start-stop system is in the opened position, the same would have to be transferred into the completely closed position with activation of the automatic start-stop system.

During the further operation of the air-conditioning system, the heating system heat exchanger then has to be initially cooled down approximately to the temperature level of the evaporator via the thermal coupling to the evaporator. The cold reservoir of the heating system heat exchanger is then only available after complete cooling down of the heating system heat exchanger, i.e. only after a certain time following the activation of the automatic start-stop system.

In an alternative configuration, the flap is in closing position even with deactivated automatic start-stop system, so that cooled air flowing away from the evaporator is permanently admitted to the heating system heat exchanger even with deactivated automatic start-stop system. Even in the deactivated state of the automatic start-stop system is the heating system heat exchanger thermally decoupled from the cooling circuit of the drive of the motor vehicle independently of the position of the flap. If the flap is already in closing position on activation of the automatic start-stop system, the cold reservoir of the heating system heat exchanger is directly available following activation of the automatic start-stop system.

For heating operation, the provision of the cold reservoir is not required anyway. In this regard, the heating system heat exchanger, for heating operation, is thermally coupled to the cooling circuit of the drive for example by opening the shut-off valve. For the regulation of the air temperature to suit requirements, the flap can take up any position between opening position and closing position in order to intermix cold and warm air.

According to a further aspect, a method for controlling an HVAC device of a motor vehicle equipped with an automatic start-stop function is additionally provided. With or upon activation of the automatic start-stop function, a heating system heat exchanger of the HVAC device in this case is thermally decoupled from a cooling circuit of a drive of the motor vehicle. In addition, the heating system heat exchanger that is typically thermally decoupled from the internal combustion engine of the motor vehicle is used as cold reservoir during a stop phase of the automatic start-stop system.

During the normal operation of the motor vehicle, in particular of its drive and its air-conditioning system, the heating system heat exchanger is cooled down to a (predetermined temperature level. It then functions as cold reservoir in a stop phase of the automatic start-stop system and can contribute that the time interval, within which the vehicle interior reaches a predetermined maximum temperature level is extended. The stop phase up to the automatic starting of the drive on reaching the maximum permissible temperature of the vehicle interior can be extended in this way without implementing additional motor vehicle components. Without having to accept reductions of air-conditioning comfort, the gross weight of the motor vehicle as well as its energy balance and fuel consumption can be further lowered in this regard.

According to a further configuration, the heating system heat exchanger with activated automatic start-stop function or on activating the start-stop function is thermally coupled to the evaporator of the air-conditioning system. Thermal coupling of the heating system heat exchanger to the evaporator of the air-conditioning system makes particularly simple and efficient cooling of the heating system heat exchanger. Accordingly, merely the evaporator of the air-conditioning system can be actively cooled because of its incorporation in the refrigerant circuit of the air-conditioning system. The heating system heat exchanger can be subjected to corresponding cooling merely through the thermal coupling to the evaporator. Separate coolants or cooling devices in this regard are dispensable and not required for the heating system heat exchanger.

According to a further configuration, air cooled down by the evaporator is admitted to the heating system heat exchanger with activated start-stop function. The thermal coupling of evaporator and heating system heat exchanger by means of air cooled down by the evaporator can be implemented in a particularly simple and cost-effective manner. Here it merely has to be ensured that preferably all air flowing away from the evaporator is conducted through or to the heating system heat exchanger. Since the heating system heat exchanger is thermally decoupled from the cooling circuit of the drive with activated start-stop function, hardly any cooling energy is lost via the heating system heat exchanger. Once the heating system heat exchanger has been cooled down to a predetermined temperature level, the air flowing into the vehicle interior via the heating system heat exchanger from the evaporator is hardly or not subjected to any thermal heating on the heating system heat exchanger.

According to a further configuration it is provided that the heating system heat exchanger with start-stop function and with activated air-conditioning system is thermally coupled or remains thermally coupled to the evaporator. In this regard, the heating system heat exchanger currently not used for heating purposes can be kept constant at a temperature level comparable to the evaporator. When activating the start-stop function the cold reservoir of the heating system heat exchanger can be made available directly.

According to a further configuration, the heating system heat exchanger with deactivated start-stop function and with activated air-conditioning system is thermally decoupled from the evaporator. To this end, a flap for example can be transferred into its opening position so that all air flowing away from the evaporator is directly fed to an outlet of the housing of the HVAC device. The flow resistance of the HVAC can thereby be reduced so that a comparatively large air mass flow, which was previously cooled down by the evaporator, can be supplied to the vehicle interior. In the case of a heating system heat exchanger that is thermally decoupled from the evaporator, the cold reservoir of the heating system heat exchanger however upon activation of the start-stop function of the cold reservoir is only available after a cooling down of the heating system heat exchanger which still has to be performed through the thermal coupling of heating system heat exchanger and evaporator to be realized then, i.e. only after a certain time interval.

According to a further aspect, a computer program for controlling an HVAC device of a motor vehicle equipped with an automatic start-stop function is finally provided. The computer program in this case includes program means tier detecting an activation of the automatic start-stop function. The computer program is operable for thermally decoupling a heating system heat exchanger of the HVAC device from a cooling circuit of a drive of the motor vehicle with activated automatic start-stop function and for thermally coupling the heating system heat exchanger to an evaporator of an air-conditioning system with activated automatic start-stop function.

Through the thermal decoupling of the heating system heat exchanger from the cooling circuit of the drive and through the thermal coupling of the heating system heat exchanger to the evaporator of the air-conditioning system, a cold reservoir for prolonging the stop phase of the automatic start-stop function can be made available. in this way, a component in the form of a heating system heat exchanger originally provided in the vehicle for heating purposes can be utilized for a further purpose. Structural adjustments are hardly necessary for this purpose provided the heating system heat exchanger can be thermally decoupled for example by means of a shut-off valve from the cooling circuit of a drive configured for example as an internal combustion engine. In this regard, the further use of the heating system heat exchanger as cold reservoir can thus be achieved by expanding the scope of the function of a control unit and thus purely through software.

According to a further embodiment, the computer program can be executed by a control of the motor vehicle, in particular by a motor vehicle control unit. The control unit is typically designed for controlling the HVAC device. It is typically coupled with suitable actuators for example for moving a flap and/or for actuating a shut-off valve.

The previously described method for controlling the HVAC device can be carried out by the motor vehicle previously described. In this regard, all features, characteristics and described advantages of the motor vehicle equally apply also to the method and vice versa. The mentioned computer program is provided in the same manner for the computer-implemented realization of the described method. In this regard, all features, characteristics and advantages described here with respect to the method for the control of the HVAC device also apply equally to the computer program and vice versa.

According to a further aspect, a device for controlling an HVAC device of a motor vehicle equipped with an automatic start-stop function is provided. The device is configured to detect an activation of the automatic start-stop function, thermally decouple a heating system heat exchanger of the HVAC device from a cooling circuit of a drive of the motor vehicle with activated automatic start-stop function as well as to thermally couple the heating system heat exchanger to an evaporator of an air-conditioning system with activated automatic start-stop function. The device for controlling the HVAC device may be implemented in a controller of the motor vehicle which is coupled to the HVAC device and designed for controlling the HVAC device.

### BRIEF DESCRIPTION OF THE DRAWINGS

The present disclosure will hereinafter be described in conjunction with the following drawing figures, wherein like numerals denote like elements.

FIG. 1 illustrates a motor vehicle in lateral view;

FIG. 2 illustrates a schematic block diagram of the HVAC device provided in the motor vehicle;

FIG. 3 is a simplified schematic representation of the HVAC device with activated automatic start-stop function;

FIG. 4 shows the HVAC device with deactivated automatic start-stop function;

FIG. 5 shows the HVAC device according to FIGS. 3 and 4 in heating mode;

FIG. 6 illustrates a diagram of two simulated measurement curves representing the heating-up of the heating system heat exchanger over time; and

FIG. 7 illustrates a flow diagram of the method for controlling the HVAC device.

### DETAILED DESCRIPTION

The following detailed description is merely exemplary in nature and is not intended to limit the invention or the application and uses of the invention. Furthermore, there is no intention to be bound by any theory presented in the preceding background or the following detailed description.

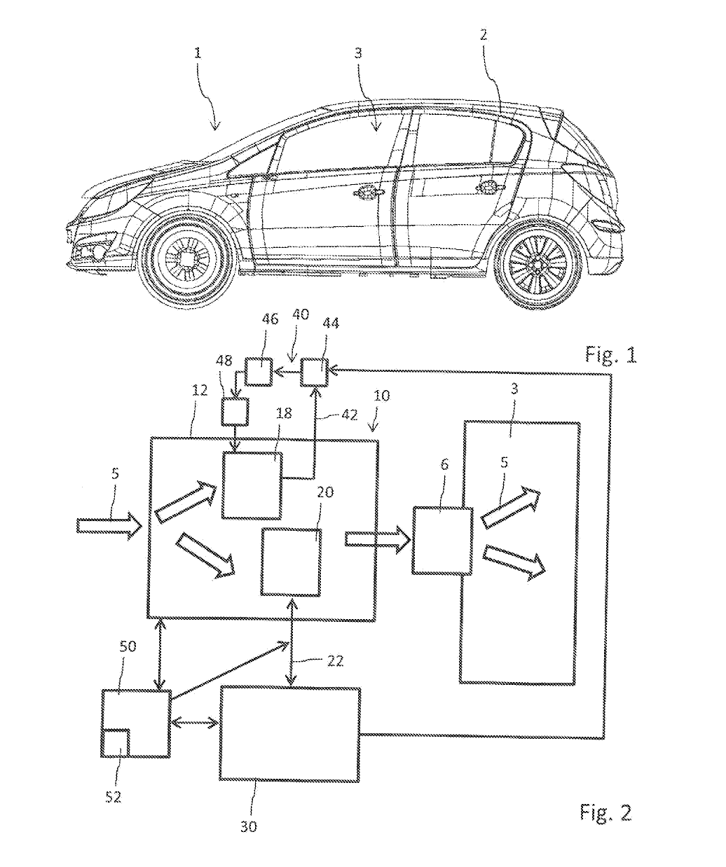

The motor vehicle 1 exemplarily shown in lateral view in FIG. 1 includes a self-supporting motor vehicle body 2 with an interior 3 functioning as a passenger cell. In the block diagram of FIG. 2, various motor vehicle components are shown. The motor vehicle 1 includes a control 50 which is equipped with an automatic start-stop system 52. By means of the automatic start-stop function the drive 30 which is typically configured in the form of an internal combustion engine can be automatically switched off and restarted with the motor vehicle 1 in the stationary state.

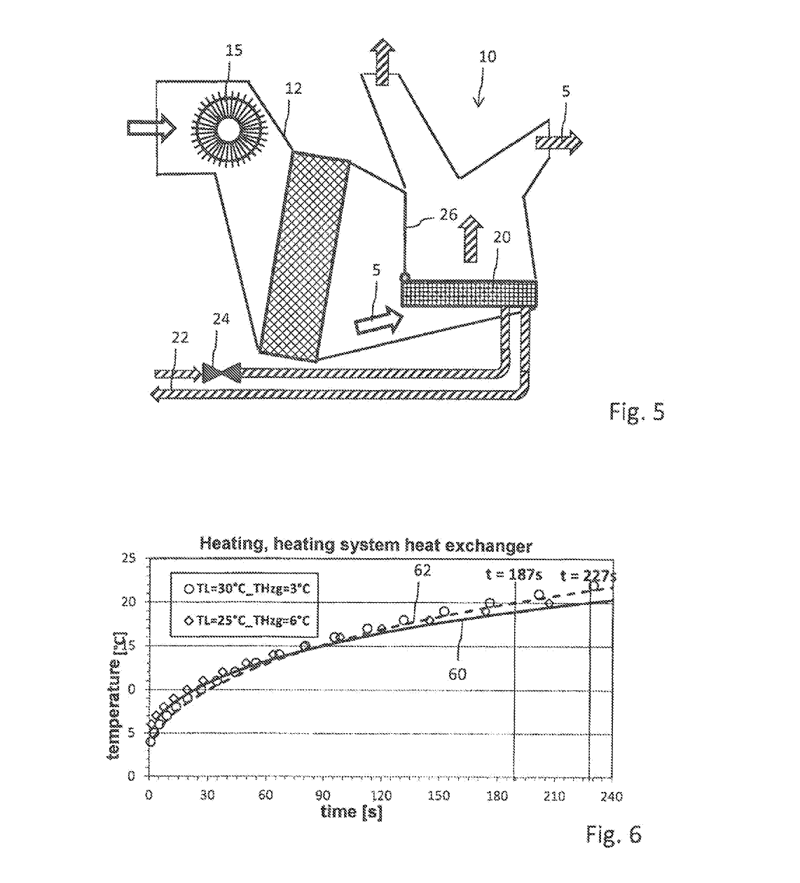

The drive 30, furthermore, can be thermally coupled to a heating system heat exchanger 20 via a cooling circuit 22. The heating system heat exchanger 20 is arranged within a housing 12 of an HVAC device 10 together with an evaporator 18 of an air-conditioning system 40. By means of the evaporator 18, the air 5 that can be fed to the HVAC device 10 can be cooled down while in the heating mode of the heating system heat exchanger 20 shown for example in FIG. 5 it can be heated to a predetermined temperature level by means of the heating system heat exchanger 20.

For the sake of completeness it is mentioned that the air-conditioning system 40 of the motor vehicle 1 includes a refrigerant circuit 42 which fluidically couples a compressor 44 driven by the drive 30, a condenser 46, an expansion valve 48 and the evaporator 18 to one another. During the operation of the air-conditioning system 40, heat can be discharged to the environment via the condenser 46 so that the evaporator 18 compared with the ambient temperature can assume a lower temperature level for cooling supplied air 5.

On the outlet side, the housing 12 of the HVAC device 10 is in flow connection with an air distribution 6, The all distribution 6 typically includes branching air ducts via which the air 5 temperature controlled via the HVAC device can be fed to the interior 3 of the motor vehicle 1.

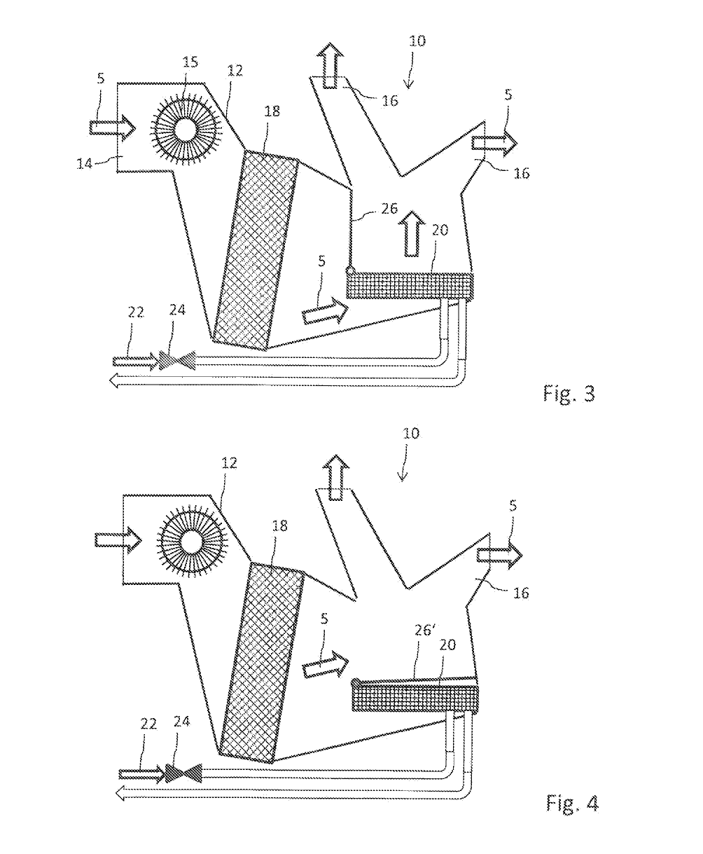

In FIG. 3, a cross section through the housing 12 of the HVAC device 10 in schematic representation is shown. The housing 12 includes an inlet 14 for the air supply and in this case two or more outlets 16 for discharging the temperature controlled air to the interior 3. Within the housing 12, typically downstream of a blower 15, the evaporator 18 of the air-conditioning system 40 to which air 5 can be admitted, is arranged. Downstream of the evaporator 18 the heating system heat exchanger 20 is provided which is incorporated in the cooling circuit 22 of the drive 30.

An inlet to the heating system heat exchanger 20 in this case can be shut off by means of a shut-off valve 24, In this way, the heating system heat exchanger 20 can be thermally decoupled from the drive 30 when required. The HVAC device 10 furthermore includes a flap 2 that is pivotably arranged in the housing 12. In the configuration of the HVAC device 10 shown in FIG. 3 the flap 26 is in a closing position. The flap 26 in the process closes off the direct flow connection from the evaporator 18 to the outlets 16.

All air 5 located downstream of the evaporator 18 is thus forced to flow along the first flow path 5a through the heating system heat exchanger 20. The configuration shown in FIG. 3 reflects a situation with switched-on air-conditioning system 40 and with activated automatic start-stop system 52. Through the closed flap 26 and through the thermal decoupling of the heating system heat exchanger 20 from the drive 30 it is achieved that the heating system heat exchanger 20 by means of the air 5 flowing away from the evaporator 18 which has already been cooled down to a predetermined temperature level is likewise cooled down to a predetermined temperature level for example in the range of the temperature level of the evaporator 18.

The heating system heat exchanger 20 then functions as cold reservoir for a stop phase of the automatic start-stop system 52. With activated automatic start-stop system 52 the drive is switched off for example on detecting the stationary state of the motor vehicle 1. As a consequence, the compressor 44 of the air-conditioning system 40 is also not drive further so that the evaporator 18 is also no longer subjected to active cooling. Since the blower 15 of the HVAC device 10 still delivers air 5 into the interior of the motor vehicle, the evaporator 18 as well as the heating system heat exchanger 20 is subjected to gradual heating. Since the heating system heat exchanger 20 complementarily to the heat or cooling capacity of the evaporator 18 makes available a complementary cold reservoir, a time interval pending the reaching of a predetermined maximum permissible temperature of the interior 3 can be extended in time. A stop phase of the drive 30 in this regard can be prolonged without noticeable losses of air-conditioning comfort.

In FIG. 4, a scenario with deactivated automatic start-stop device 52 deviating from the former is shown. Although the HVAC device 10 with deactivated automatic start-stop system 52 in a configuration shown in FIG. 3 can continue to be operated unchanged, it can be provided in the configuration according to FIG. 4 deviating from this, to still thermally decouple the heating system heat exchanger 20 from the drive 30 by means of the shut-off valve 24.

In comparison with FIG. 3 however it is provided with the configuration according to FIG. 4 to transfer the flap into an opening position 26. In this position, the air 5 flowing away from the evaporator 18 can flow unhindered and directly along the second flow path 5b and thus subject to bypassing the heating system heat exchanger 20 to the outlets 16 of the housing 12 and thus into the air distribution 6 and into the interior 3. The heating system heat exchanger 20 in this process is largely bypassed in terms of flow. In this regard it is subjected to far less cooling through the air 5 flowing away from the evaporator 18. In the configuration shown in FIG. 4 the flow resistance, in comparison with the configuration shown in FIG. 3, of the HVAC device is reduced so that with constant output of the blower 15 a larger air mass flow can be fed to the vehicle interior 3.

Upon activation of the automatic start-stop system 52 at the latest, the flap 26 would have to be transferred again into its closed position shown in FIG. 3 so that the heating system heat exchanger 20 is cooled down by means of the air 5 already cooled down by the evaporator 18.

In FIG. 5, the conventional operation of the HVAC device 10 is finally shown. Here, the shut-off valve 24 is opened so that a thermal coupling of the heating system heat exchanger 20 to the drive 30 is realized and the heating system heat exchanger 20 can heat the air 5 fed to it in the predetermined manner.

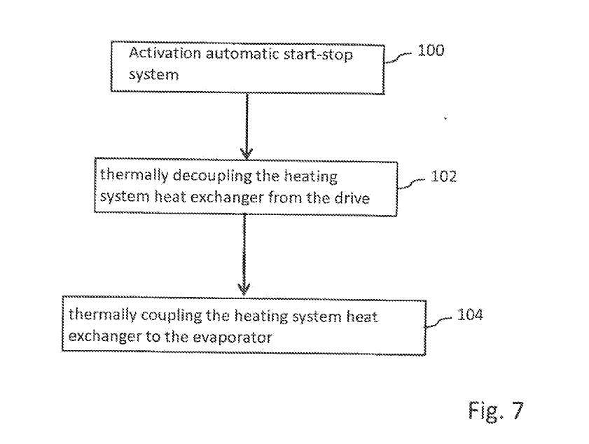

In FIG. 6, the heating of the heating system heat exchanger 20 over time is shown by means of two simulated curves. The curve 60 represents a case of an air inlet temperature of 30° C. and a temperature of the heating system heat exchanger of 3° C. Without taking into account the cooling output of the evaporator and with an air mass flow of 230 kg/h 187 seconds pass until the heating system heat exchanger 20 reaches a permissible end temperature of 20° C. The curve 62 reflects a case that is comparable to this in which the air inlet temperature is 25° C. and the initial temperature of the heating system heat exchanger 20 is 6° C. With constant air mass flow, 227 seconds pass in the process until the heating system heat exchanger 20 reaches the maximum permissible temperature of 20° C.

As is evident from the diagrams of FIG. 6, the stop phase of an automatic start-stop system 52 of a motor vehicle 1 can be extended and prolonged by several minutes with switched-on air-conditioning system 40 by using the heating system heat exchanger 20 as cold reservoir.

In FIG. 7, a flow diagram of the method for controlling the HVAC device 10 is finally schematically shown. In a first step 100 the automatic start-stop function of the motor vehicle 1 is activated for example. As a consequence of the activation, the thermal decoupling of the heating system heat exchanger 20 from the drive 30 of the motor vehicle 1, for example by closing the shut-off valve 24 provided in the cooling circuit 22 initially takes place in a step 102. In a further subsequent step 104, the heating system heat exchanger 20 is finally thermally coupled to the evaporator 18 of the air-conditioning system 40 of the motor vehicle 1 in order to cool the same itself to a predetermined temperature level, preferentially in the range of the temperature of the evaporator 18. In this way, the heating system heat exchanger 20 can be used as cold reservoir during the operation of the air-conditioning system 40 and with activated automatic start-stop function of the motor vehicle 1.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

1-14. (canceled)

15. A motor vehicle having a drive with an automatic start-stop system and an HVAC device comprising a heating system heat exchanger that can be thermally coupled to the drive, and an evaporator that is incorporated in a refrigerant circuit of an air-conditioning system, wherein in the HVAC device includes first and second flow paths for supplying air downstream of the evaporator, wherein the first flow path leads through the heating system heat exchanger, and the second flow path leads past the heating system heat exchanger, and wherein, with an activated automatic start-stop system, the heating system heat exchanger is thermally decoupled from the drive and used as cold reservoir such that air flowing via the first flow path is admitted to the heating system heat exchanger during a stop phase of the automatic start-stop system.

16. The motor vehicle according to claim 15, wherein the heating system heat exchanger with an activated automatic start-stop system is thermally decoupled from the drive.

17. The motor vehicle according to claim 15, wherein the heating system heat exchanger with an activated automatic start-stop system is thermally coupled to the evaporator.

18. The motor vehicle according to claim 15, wherein the HVAC device comprises a flap which can be transferred into a closed position with an activated automatic start-stop system, in which air cooled down by the evaporator, is admitted to the heating system heat exchanger.

19. The motor vehicle according to claim 18, wherein the flap with deactivated automatic start-stop system is configured to be transferred into closing position or into an opening position, wherein the air flowing away from the evaporator with opened flap flows into a vehicle interior subject to bypassing the heating system heat exchanger.

20. The motor vehicle according to claim 15, wherein the heating system heat exchanger is incorporated in a cooling circuit that is thermally coupled to the drive and wherein the cooling circuit comprises at least one shut-off valve configured to thermally decoupled the drive for the heating system heat exchanger with an activated automatic start-stop system.

21. The motor vehicle according to claim 15, wherein the air-conditioning system comprises a compressor that is driven by the drive, which is controllable for at least regulating the air temperature with an activated automatic start-stop system.

22. A method for controlling an HVAC device of a motor vehicle equipped with an automatic start-stop function, wherein upon activation of the automatic start-stop function the method comprises:
thermally decoupling a heating system heat exchanger of the HVAC device from a cooling circuit of a drive of the motor vehicle; and
using the heating system heat exchanger as a cold reservoir in a stop phase of the automatic start-stop system.

23. The method according to claim 22, further comprising thermally coupling an evaporator of an air-conditioning system with the heating system heat exchanger with an activated automatic start-stop function.

24. The motor vehicle according to claim 23, further comprising thermally coupling the evaporator and the heating system heat exchanger with deactivated automatic start-stop function and with an activated air-conditioning system.

25. The motor vehicle according to claim 23, further comprising thermally decoupling the evaporator and the heating system heat exchanger with deactivated automatic start-stop function and with an activated air-conditioning system.

26. The motor vehicle according to claim 23, further comprising admitting air cooled down by the evaporator into the heating system heat exchanger with an activated automatic start-stop function.

27. The motor vehicle according to claim 26, further comprising thermally coupling the evaporator and the heating system heat exchanger with deactivated automatic start-stop function and with an activated air-conditioning system.

28. The motor vehicle according to claim 26, further comprising thermally coupling the evaporator and the heating system heat exchanger with deactivated automatic start-stop function and with an activated air-conditioning system.

29. A programmed computer product for controlling an HVAC device of a motor vehicle equipped with an automatic start-stop function, the programmed computer product comprising a processor configured to execute a computer program stored in a non-transitory computer readable medium and operable to:
thermally decouple a heating system heat exchanger of the HVAC device from a cooling circuit of a drive of the motor vehicle with an activated automatic start-stop function; and
thermally couple the heating system heat exchanger to an evaporator of an air-conditioning system with the activated automatic start-stop function.

30. The programmed computer product according to claim 29, wherein the processor comprises a control of the motor vehicle, which is coupled to the HVAC device and configured to control the HVAC device.
